(19) United States
(12) Patent Application Publication
(10) Pub. No.: US 2006/0082663 A1
(43) Pub. Date: Apr. 20, 2006

(54) Video camera

(76) Inventors: Jan Van Rooy, 's-Hertogenbosch (NL); Jeff James Rosica, Beverly Hills, CA (US)

Correspondence Address: THOMSON LICENSING INC., PATENT OPERATIONS, PO BOX 5312, PRINCETON, NJ, 08543-5312, US

(21) Appl. No.: 10/966,287

(22) Filed: Oct. 15, 2004

(51) Int. Cl. H04N 5/225; H04N 7/64; H04N 5/76

(52) U.S. Cl. 348/231.99; 348/218.1

(57) ABSTRACT

A video camera has a lens, an image sensor for generating a first video signal representative of a scenery which is imaged on the image sensor by said lens, an auxiliary image signal source providing a second video signal, an output interface for outputting a third video signal, and signal mixing means for combining said third video signal from said first and second video signals.

### FIELD OF THE INVENTION

The present invention generally relates to a video camera.

### BACKGROUND OF THE INVENTION

In a normal television production set-up, several cameras are used for shooting a scene from different views, and a cameraperson operates each camera. Additionally, there may be an overview camera with a fixed position that does not require a cameraperson to operate it. Mixing the signals of the cameras, adding effects or colour keying are done in a switching apparatus which receives the video signals from the various cameras and, if present, from auxiliary video image sources such as a video player or a computer. The mixing apparatus requires another person to operate it, which makes this conventional style of television production cost and labour intensive.

It is possible to reduce the number of staff in some situations by having the operator of the mixing apparatus control remotely one or more of the cameras. However, this operator, not being present on the scene which is being shot, has to rely on the images provided by the cameras when deciding how to control them, and can therefore not react as spontaneously as a cameraperson who perceives the scene directly with all his senses.

In some situations, cameras and staff may be saved by using one camera for a multiple angle shot. For instance in an interview situation, the interviewed person is filmed first, and the pictures of the interviewer are shot in a second take, after the real interview, and mixed into the recording afterwards. This often looks very unnatural and requires extra cutting work, and the interviewed person must be willing to remain seated for over-the-shoulder shots towards the interviewer.

Another typical situation is a CEO presenting the financial figures of his company in a slide presentation. The keying that allows him to virtually walk in front of his slides must at present be done with elaborate mixing equipment live during production, or accomplished later in post-production. Avoiding the additional staff and equipment for the elaborate live production, or perhaps an additional post-production step, would save costs and cut complexity.

In view of this there exists a need to provide a video camera which allows to reduce the cost of video production by reducing the amount of staff and equipment required either live during production, or for later post-production, that is needed to obtain a finished program from the video signal.

### SUMMARY OF THE INVENTION

One embodiment of the present invention proposes a video camera having a lens, an image sensor for generating a first video signal representative of a scenery which is imaged on the image sensor by said lens, an auxiliary image signal source providing a second video signal, an output interface for outputting a third video signal, and signal mixing means for combining said third video signal from said first and second video signals. This camera allows the camera person to carry out at least part of the mixing or special effects which is are conventionally done either with additional live production equipment or in post-production, thus directly providing, as said third video signal, a judicious combination of the first and second ones. Further features and advantages of the present invention will become apparent from the subsequent description of embodiments thereof, referring to the appended drawings.

### BRIEF DESCRIPTION OF THE DRAWINGS

Preferred embodiments of the present invention will be described below in more detail, with reference to the accompanying drawings, in which:

FIG. 1 is a schematic block diagram of a video camera of the invention; and,

FIG. 2 illustrates a typical application of a camera system comprising the camera of the invention.

### DETAILED DESCRIPTION

Generally, a video camera comprises a lens, an image sensor such as a CCD for generating a first video signal representative of a scenery, which is imaged on the image sensor by the lens, and an output interface for outputting the video signal from the image sensor to a recording device which may be incorporated in the camera body or be connected to it by a signal cable or a wireless connection. The video signal may also be output to a remote mixing apparatus, where the signal from the camera is combined with video signals from other sources, such as another camera, a video player, a computer and the like.

According to a first embodiment of the invention, the auxiliary image signal source is a storage unit built into said camera. Such a storage unit may store one or more still images or even a video sequence, which may be combined with the first video signal in said signal mixing means by keying, so that in a frame of the third video signal, there is an image region taken from the first video signal and another region taken from the second video signal.

In one embodiment of the invention, the video camera comprises a converter for converting said second video signal from a graphic image file, thus enabling a computer generated image file having any known format such as JPG, TIFF or the like to be input into the storage unit of the camera without further processing.

According to another embodiment, the auxiliary image signal source is a video signal input interface. Of course, this embodiment and the previous one can be combined by providing one or more auxiliary image sources of each type. The video signal input interface allows to supply to the camera as said second video signal a signal which is played back from a recording or a signal which is just being taken by another camera. This enables the cameraperson operating the camera of the invention to change over at will from one camera to the other, thus providing a third video signal in which takes of the first and second cameras alternate.

According to one embodiment of the invention, the auxiliary image signal source is a video signal input interface, and the video camera of the invention comprises a remote-controlled transmitter means for transmitting a desired value of at least one operating parameter of a remote-controlled secondary camera, specifically the camera connected to the video signal input interface, thus enabling remote control of the secondary camera by the camera of the invention.

Preferably, the camera of the invention comprises a phase detector for detecting a phase difference between said first and second video signals, and the controlled parameter is the phase of the second video signal. Thus, the camera of the invention can control the phase of the video signal from the secondary camera, so that first and second video signals are in phase at the signal mixing means, and mixing may be achieved by simply switching over from one of these video signals to the other.

The camera may also comprise a user interface where a camera person can input said at least one desired value. This is particularly appropriate if the operating parameter is a pan or tilt angle, a focal length, brightness, white balance or any other parameter, which the camera person may be free to control at the camera of the invention itself, too. In this way, the cameraperson has the same control of the secondary camera as of the camera of the invention, which he is handling directly. Unlike the operator of a mixing apparatus, the cameraperson is physically present at the filmed scene and is therefore able to control the cameras much more spontaneously based not only on what the cameras see but also on what he perceives himself.

Of course, the camera of the invention may comprise remote-controlled receiver means that enable it to be remotely controlled. In that case, its remote-controlled receiver means is preferably adapted for receiving said at least one desired controlled parameter of the secondary camera, too, in order to enable control of the secondary camera in a daisy-chain fashion.

The mixing means of the video camera may have a variety of operating modes that may be set at different times, e.g. first operating mode in which one or more frames of said first video signal are output as the third video signal, a second operating mode in which one or more frames of the second video signal are output, a third operating mode in which one or more frames are output in which a first region is taken from the first video signal and a second region is taken from the second video signal and a fourth operating mode in which said first and second video signals are superimposed. The third and fourth modes may be used for gradually switching from first to second mode and back by gradually decreasing the region taken from the first video signal and increasing the region taken from the second video signal or vice versa or by shifting weighting factors in the superposition. A type of third mode may also be used when, e.g., a person is filmed by the camera of the invention before a blank background, and the background is replaced in the signal mixing means by a background image from the auxiliary image signal source.

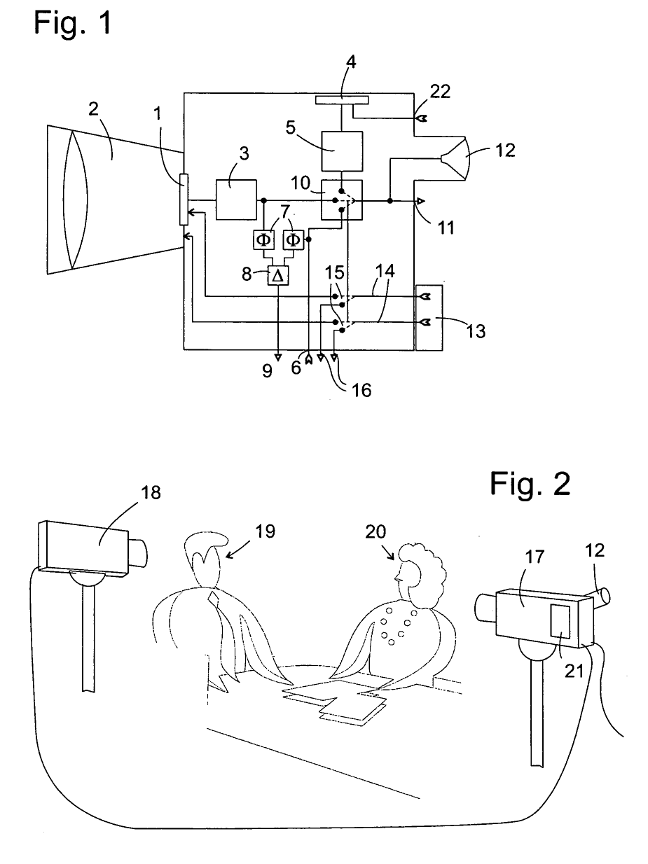

FIG. 1 is a high schematic block diagram of a video camera according to the present invention. It comprises an image sensor 1, e.g. a CCD, a lens 2 for projecting an image of a scenery onto the image sensor 1, a first modulator circuit 3 for reading image data from the image sensor 1 at a given frame rate and converting these into a conventional video signal formed of successive frames, each of which comprises a number of lines, horizontal and vertical synchronization impulses, etc. Though the description refers only to cameras having one image sensor 1 the invention also applies to cameras having a plurality of image sensors 1, in particular the invention can be implemented in cameras having three image sensors.t

A first auxiliary image source is formed of a solid state storage device 4 for storing one or more image files in a conventional file format such as JHPC, TIFF or the like, and a second modulator circuit 5 for reading image date from the storage device 4 and converting them into a video signal having the same format as that of modulator circuit 3. The storage device 4 e.g. is a solid state storage, a hard disk, an optical disk or any other suitable device. The solid state storage device may be a removable component which has image data written into it by a writing apparatus, not shown, prior to its installation in the camera, or a digital interface 22, e.g. a USB interface, may be provided for downloading image data into the storage device 4. Modulator circuits 3, 5 are controlled by a common clock, not shown, so as to output video signals at a same phase.

Another auxiliary image signal source is a video signal input interface 6, which, in the simplest case, may be a simple connector to which an external source such as a video player or a slave camera may be connected.

There are two-phase detector circuits 7 which extract the vertical synchronization impulses from the video signals coming from the first modulator circuit 3 and the input interface 6, respectively, and provide these to a delay measuring circuit 8. An output signal of the delay measuring circuit 8 which is representative of the phase difference between the two video signals is output at connector 9 in order to be received by the external signal source connected to interface 6 and to control the phase thereof, so as to synchronize the phases detected by detector circuits 7.

The camera further comprises mixing means 10, schematically represented in the Figure as a switch. A video signal output port 11 of the camera and a viewfinder 12 are connected to the output of the mixing means 10.

In the simplest case, the mixing means 10 can indeed be a simple switch which selectively outputs one of the signals from modulator circuit 3, modulator circuit 5 or input interface 6 as the output signal of the camera. Preferably, the mixing means 10 has a variety of more sophisticated mixing functions, e.g. a function which yields an output video signal by taking a first region of a frame from one input video signal and the second region from another. Such a function may e.g. be used for replacing a blank background of a scene which is recorded by the camera by a background from the storage device 4 or from the slave camera, or for gradually switching the output video signal from one signal source to another.

Another advanced mixing function is to form an output signal by superimposing two input video signals, i.e. by calculating colour and brightness of each pixel of the output signal as a weighted average of corresponding pixels of two input signals. By gradually shifting the weighting factors, a continuous switchover from one signal source to the other is possible.

Finally, a frequently used advanced mixing function allows to downscale one picture or several pictures and to put them in a kind of frame inside another picture. For example in news broadcasts a picture of an event is presented above the shoulder of a presenter reporting about this event.

The camera has a user interface 13, where the cameraperson may input desired values of various operating parameters of the camera such as focal length, exposure time, pan and tilt angles, etc. These desired values are supplied to the image sensor 1, the lens 2 or to motors of a camera base, not shown, via lines 14. In the lines 14, there is a switch 15, the position of which is coupled to the operating mode set at the mixing means 10. When the mixing means 10 output the video signal from lens 2, the switches 15 are in position to supply the desired values to the corresponding elements of the camera. On the other hand, when the mixing means 10 outputs the video signal from input interface 6, the switches 15 transmit the desired values to output connectors 16 for transmission to the slave camera. I.e. when the video signal output at output port 11 and displayed by view finder 12 is that of the camera itself, the user interface 13 controls this camera, whereas if the signal at output port 11 and in the viewfinder 12 is that of the slave camera, the slave camera is controlled by user interface 13.

The camera of FIG. 1 can control a slave camera but is not adapted to be remotely controlled itself. However, if desired, a remote-controlled receiving interface can be provided which, when in use, takes precedence over user interface 13. The provision of such a remote-controlled receiver interface not only enables the camera to operate as a slave camera itself or to control it by a conventional remote switching apparatus, but also to form a daisy-chain of three or more cameras in which each intermediate camera is slave to a predecessor and master to a successor camera.

FIG. 2 schematically shows an exemplary operating environment for a camera system comprising a camera 17 as described above referring to FIG. 1, and a slave camera 18 controlled by camera 17. The cameras 17, 18 are shooting an interview. Camera 17 is directed towards an interviewed person 19 and slave camera 18 towards an interviewer 20. At a side of the body of camera 17 there is a touch panel 21 where icons or names of camera operating parameters, presently set values of these parameters and possible other values thereof are displayed.

A cameraperson, not shown, may set desired values of any of these parameters by touching one of the displayed possible values. Further, the cameraperson may switch over from camera 17 to slave camera 18 whenever the interviewed person 19 has stopped speaking and the interviewer 20 asks a new question. In this way, a ready-to-broadcast programme of the interview can be obtained without the need for post-production. While the camera 17 is active, inputs to touch panel 21 control the operation of the camera 17 itself.

On the other hand, if the slave camera 18 is active and the video signal output from camera 17 is that obtained by camera 18, the parameters displayed on touch panel 21 are those of camera 18, and settings effected by the cameraperson by touching the touch panel 21 take effect on slave camera 18. Thus the settings always have the expected effect on the image displayed in the viewfinder 12, regardless which camera provides the image displayed in the viewfinder 12. When the cameraperson switches back to camera 17, settings carried out at the touch panel 21 have effect on it again.

While foregoing is directed to various example embodiments, including preferred embodiments of the present invention, other and further embodiments of the invention may be devised without departing from the basic scope thereof, and the scope thereof is determined by the claims that follow.

What is claimed is:

1. A video camera having a lens, an image sensor for generating a first video signal representative of a scenery which is imaged on the image sensor by said lens, an auxiliary image signal source providing a second video signal, an output interface for outputting a third video signal, and signal mixing means for combining said third video signal from said first and second video signals.

2. The video camera according to claim 1, wherein the auxiliary image signal source comprises a storage unit built into said camera.

3. The video camera according to claim 2, comprising a converter for converting said second video signal from a graphic image file.

4. The video camera according to claim 1, wherein the auxiliary image signal source is a video signal input interface.

5. The video camera of claim 4, comprising remote control transmitter means for transmitting a desired value of at least one operating parameter of a remote-controlled secondary camera.

6. The video camera of claim 5, comprising a phase detector (8) for detecting a phase difference between said first and second video signals, wherein said control parameter is the phase of the second video signal.

7. The video camera of claim 5, comprising a user interface for receiving said at least one desired value.

8. The video camera of claim 7, wherein the user interface comprises a display panel for displaying available options of values of said at least one operating parameter and input means for selecting among the displayed options.

9. The video camera of claim 5, further comprising remote control receiver means for receiving said at least one desired value.

10. The video camera of claim 6, further comprising remote control receiver means for receiving said at least one desired value.

11. The video camera of claim 7, further comprising remote control receiver means for receiving said at least one desired value.

12. The video camera of claim 8, further comprising remote control receiver means for receiving said at least one desired value.

13. The video camera according to claim 1, wherein the signal mixing means is adapted to combine the first and second video signals by outputting, in a first operating mode, one or more frames of said first video signal and, in a second operating mode, one or more frames of said second video signal.

14. The video camera of claim 13, wherein the signal mixing means is further adapted to combine the first and second video signals by outputting, in a third operating mode, one or more frames in which a first region is taken from the first video signal and a second region is taken from the second video signal.

15. The video camera of claim 13, wherein the signal mixing means (10) is further adapted to combine the first and second video signals by outputting, in a fourth operating mode, a superposition of said first and second video signals.

16. The video camera of claim 14, wherein the signal mixing means (10) is further adapted to combine the first and second video signals by outputting, in a fourth operating mode, a superposition of said first and second video signals.

17. A camera system comprising a master camera according to claim 1 and a slave camera connected to the master camera (17) as the auxiliary image source thereof.
